(19) United States
(12) Patent Application Publication
(10) Pub. No.: US 2017/0034707 A1
(43) Pub. Date: Feb. 2, 2017

(54) INTELLIGENT DYNAMIC FREQUENCY SELECTION TECHNIQUES

(71) Applicant: QUALCOMM Incorporated, San Diego, CA (US)

(72) Inventors: Michael Richard Green, Needham, MA (US); Meriam Rezk, Campbell, CA (US); Youhan Kim, San Jose, CA (US); Mahboobul Alem, Fremont, CA (US)

(21) Appl. No.: 14/810,301

(22) Filed: Jul. 27, 2015

(51) Int. Cl. H04W 16/10; H04W 16/14; G01S 7/02

(52) U.S. Cl. CPC H04W 16/10; G01S 7/021; H04W 16/14

(57) ABSTRACT

Methods, systems, and apparatuses are described for wireless communications. More particularly, an access point may assign a channel weighting factor to each channel in a candidate channel list. The access point may identify an attribute of a radar signal detected on a current operating channel. The access point may adjust, based at least in part on the identified attribute, the channel weighting factor assigned to a channel of the candidate channel list adjacent to the current operating channel. The access point may select a new operating channel from the candidate channel list based at least in part on the assigned channel weighting factor.

### BACKGROUND

Field of the Disclosure

The present disclosure, for example, relates to wireless communication systems, and more particularly to dynamic frequency selection techniques in a wireless communication system.

Description of Related Art

Wireless communications systems are widely deployed to provide various types of communication content such as voice, video, packet data, messaging, broadcast, and so on. These systems can be multiple-access systems capable of supporting communication with multiple users by sharing the available system resources (e.g., time, frequency, and power). A wireless network, for example a Wireless Local Area Network (WLAN) can include an access point (AP) that may communicate with stations (STAs) or mobile devices. The AP may be coupled to a network, such as the Internet, and enable a mobile device to communicate via the network (and/or communicate with other devices coupled to the access point).

An AP of a WLAN may perform various scans to determine which channels are available for use and, based at least in part on the scans, populate a candidate channel list (CCL). Dynamic frequency selection (DFS) is a spectrum-sharing mechanism that allows WLAN devices operating in the 5 GHz band to coexist with radar systems operating in the same band. DFS can provide for the AP to perform a channel availability check (CAC) to search for radar pulses in the frequency channel where the AP is operating, or during an automatic channel scan. If the AP detects a radar signal in a current channel of operation, the AP discontinues operation on that channel and begins to operate on a different frequency after checking that the new frequency is free of radar signals. For the channel with the detected radar signal, the AP adds this channel to a non-occupancy list (NOL) and refrains from using these channels, e.g., for at least thirty (30) minutes.

According to current configurations, the AP can select the next available channel from the CCL to move to once a radar signal is detected. For example, the AP may randomly select a channel from the CCL and begin utilizing that channel for communications. This, however, does not provide optimal communication performance.

### SUMMARY

The present description generally relates to improved systems, methods, apparatuses, or computer-readable media for wireless communications. More particularly, the described features relate to techniques for a robust channel selection scheme that provides for a more intelligent channel selection during dynamic frequency selection (DFS) operations. An access point (AP) may assign a channel weighting factor to the channels listed in the CCL and, upon detecting a radar signal, select a channel from the candidate channel list (CCL) based at least in part on the channel weighting factor. For example, the AP may perform a scanning procedure to identify channel(s) available for communication, e.g., select channels based at least in part on channel characteristics, based at least in part on channel availability check (CAC) procedures, based at least in part on neighboring wireless systems (e.g., LTE wireless communication systems), and the like. Generally, the channel weighting factor may provide an indication of various performance metrics associated with the channel, e.g., allowable transmission power for the channel, a known radar signal associated with the channel, an allowable false detection rate for detecting radar signals on the channel, etc. The AP may determine that a radar signal has been detected on an operating channel and select a channel from the CCL based at least in part on the channel weighting factor for the channel.

The AP may update the channel weighting factor for the channel(s) based at least in part on an attribute of the detected radar signal. The AP may adjust the channel weighting factor assigned to a channel of the CCL that is adjacent to the current operating channel. For example, the AP may determine whether the detected radar signal is associated with the channels (e.g., a radar bandwidth characteristic), a type of radar signal detected (e.g., a radar type characteristic), a Fast-Fourier Transform (FFT) attribute of the radar signal, and the like. Accordingly, the AP may adjust the channel weighting factor for at least some of the channels on the CCL based at least in part on the radar characteristic. For example, where the radar is detected on a single channel, the AP may lower the channel weighting factor for adjacent channels (e.g., the channel above and the channel below) the channel with the detected radar signal.

A method for wireless communication is described. The method may include identifying an attribute of a radar signal detected on a current operating channel; and adjusting, based at least in part on the identified attribute, a channel weighting factor assigned to a channel of a candidate channel list (CCL_adjacent to the current operating channel, wherein each channel in the CCL is associated with a channel weighting factor.

The method may include selecting a new operating channel from the CCL based at least in part on the channel weighting factor. The method may include assigning each channel in the CCL to a radar classification; and identifying a priority metric associated with a channel change between channels of the CCL, wherein the channel change is based at least in part on the radar classification. The radar classification may include a radar cleared classification. The method may include determining that the priority metric associated with the channel change is a first priority metric; and selecting a new operating channel from the channels assigned to the radar cleared classification and having a highest channel weighting factor.

The radar classification may include a non-radar cleared classification. The method may include determining that the priority metric associated with the channel change is a first priority metric; failing to identify a channel assigned to a radar cleared classification; selecting a new operating channel from the channels assigned to the non-radar cleared classification and having a highest channel weighting factor; and performing a scan procedure on the new operating channel prior to communicating on the new operating channel.

The method may include determining that the priority metric associated with the channel change is a second priority metric; identifying a first channel assigned to a radar cleared classification and having a first highest channel weighting factor; identifying a second channel assigned to a non-radar cleared classification and having a second highest channel weighting factor; and selecting the second channel based at least in part on a difference between the channel weighting factor of the second channel and the channel weighting factor of the first channel exceeding a predetermined threshold.

The method may include performing a scan procedure on the second channel prior to communicating on the second channel. The method may include determining that the priority metric associated with the channel change is a second priority metric; identifying a first channel assigned to a radar cleared classification and having a first highest channel weighting factor; identifying a second channel assigned to a non-radar cleared classification and having a second highest channel weighting factor; and selecting the first channel based at least in part on a difference between the channel weighting factor of the first channel and the channel weighting factor of the second channel being below a predetermined threshold.

The attribute of the detected radar signal may be a bandwidth. The method may include determining that the bandwidth of the detected radar signal spans the current operating channel and an adjacent channel; and refraining from adjusting the channel weighting factor for the adjacent channel. The method may include determining that the bandwidth of the detected radar signal is within a bandwidth of the current operating channel; and adjusting the channel weighting factor for an adjacent channel above the current operating channel and for an adjacent channel below the current operating channel.

A device for wireless communication is described. The device may include a radar scan manager to identify an attribute of a radar signal detected on a current operating channel; and a channel selector to adjust, based at least in part on the identified attribute, a channel weighting factor assigned to a channel of a candidate channel list (CCL) adjacent to the current operating channel, wherein each channel in the CCL is associated with a channel weighting factor.

The device may include selecting a new operating channel from the CCL based at least in part on the channel weighting factor. The CCL manage is further to assign each channel in the CCL to a radar classification; and wherein the CCL manager is further to identify a priority metric associated with a channel change between channels of the CCL, wherein the channel change is based at least in part on the radar classification.

The radar classification may include a radar cleared classification. The CCL manager is further to determine that the priority metric associated with the channel change is a first priority metric; and wherein the channel selector is further to select a new operating channel from the channels assigned to the radar cleared classification and having a highest channel weighting factor.

The radar classification may include a non-radar cleared classification. The device wherein the CCL manager is further to determine that the priority metric associated with the channel change is a first priority metric; wherein the CCL manager is further to fail to identify a channel assigned to a radar cleared classification; wherein the channel selector is further to select a new operating channel from the channels assigned to the non-radar cleared classification and having a highest channel weighting factor; and wherein the CCL manager is further to perform a scan procedure on the new operating channel prior to communicating on the new operating channel.

The device wherein the CCL manager is further to determine that the priority metric associated with the channel change is a second priority metric; wherein the CCL manager is further to identify a first channel assigned to a radar cleared classification and having a first highest channel weighting factor; wherein the CCL manager is further to identify a second channel assigned to a non-radar cleared classification and having a second highest channel weighting factor; and wherein the channel selector is further to select the second channel based at least in part on a difference between the channel weighting factor of the second channel and the channel weighting factor of the first channel exceeding a predetermined threshold.

The device wherein the CCL manager is further to perform a scan procedure on the second channel prior to communicating on the second channel. The device wherein the CCL manager is further to determine that the priority metric associated with the channel change is a second priority metric; wherein the CCL manager is further to identify a first channel assigned to a radar cleared classification and having a first highest channel weighting factor; wherein the CCL manager is further to identify a second channel assigned to a non-radar cleared classification and having a second highest channel weighting factor; and wherein the channel selector is further to select the first channel based at least in part on a difference between the channel weighting factor of the first channel and the channel weighting factor of the second channel being below a predetermined threshold.

The attribute of the detected radar signal may be a bandwidth. The device wherein the radar scan manager is further to determine that the bandwidth of the detected radar signal spans the current operating channel and an adjacent channel; and wherein the channel selector is further to refrain from adjusting the channel weighting factor for the adjacent channel. The device wherein the radar scan manager is further to determine that the bandwidth of the detected radar signal is within a bandwidth of the current operating channel; and wherein the channel selector is further to adjust the channel weighting factor for an adjacent channel above the current operating channel and for an adjacent channel below the current operating channel.

An apparatus for wireless communications is described. The apparatus may include means for identifying an attribute of a radar signal detected on a current operating channel; and means for adjusting, based at least in part on the identified attribute, a channel weighting factor assigned to a channel of a candidate channel list (CCL) adjacent to the current operating channel, wherein each channel in the CCL is associated with a channel weighting factor.

The apparatus may include means for selecting a new operating channel from the CCL based at least in part on the channel weighting factor. The apparatus may include means for assigning each channel in the CCL to a radar classification; and means for identifying a priority metric associated with a channel change between channels of the CCL, wherein the channel change is based at least in part on the radar classification.

A non-transitory computer-readable medium storing computer-executable code for wireless communications is described. The code executable by a processor to identify an attribute of a radar signal detected on a current operating channel; and adjust, based at least in part on the identified attribute, a channel weighting factor assigned to a channel of a candidate channel list (CCL) adjacent to the current operating channel, wherein each channel in the CCL is associated with a channel weighting factor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system, in accordance with various aspects of the present disclosure;

FIG. 2 illustrates an example of an access point performing intelligent dynamic frequency selection techniques in a wireless network, in accordance with various aspects of the present disclosure;

FIG. 3 shows a block diagram of an example of an access point that may be used in wireless communication, in accordance with various aspects of the present disclosure;

FIG. 4 shows a block diagram of another example of an access point that may be used in wireless communication, in accordance with various aspects of the present disclosure;

FIG. 5 shows a block diagram of an example of a candidate channel list manager may be used in wireless communication, in accordance with various aspects of the present disclosure;

FIG. 6A shows a block diagram illustrating an example of an architecture for an access point, in accordance with various aspects of the present disclosure;

FIG. 6B shows a block diagram illustrating another example of an architecture for an access point, in accordance with various aspects of the present disclosure;

FIG. 7 is a flow chart illustrating an example of a method for wireless communications, in accordance with various aspects of the present disclosure;

FIG. 8 is a flow chart illustrating an example of a method for wireless communications, in accordance with various aspects of the present disclosure;

FIG. 9 is a flow chart illustrating an example of a method for wireless communications, in accordance with various aspects of the present disclosure; and

FIG. 10 is a flow chart illustrating an example of a method for wireless communications, in accordance with various aspects of the present disclosure.

### DETAILED DESCRIPTION

Dynamic frequency selection (DFS) techniques permit Wireless Local Area Network (WLAN) and radar systems to coexist without interference. Generally, the concept of dynamic frequency selection (DFS) is to have WLAN devices communicating on an operating channel or frequency and detect the presence of a radar signal on the operating channel and, if the level of radar signal is above a certain threshold, vacate that channel and select an alternate channel. Different types of radar systems utilize radar signals with varying signal attributes, e.g., transmission bandwidth, transmission periodicity, signal type, etc. As one example, air traffic control and navigation radar systems may utilize one type of radar signal that is different from a signal type used by a weather sensing radar system. A WLAN device that detects a radar signal may, in certain aspects, be able to identify certain attributes of the radar signal and, based at least in part on those attributes, know a priori the other attributes of the radar system and its signal transmissions. Currently, WLAN devices may not consider attributes of the radar signal and other characteristics of the channels and/or current communication may load when selecting or prioritizing other channels of the CCL.

The present description generally relates to improved systems, methods, apparatuses, or computer-readable media for wireless communications in a WLAN device, e.g., in an access point (AP) and/or a station (STA). For simplicity, the present disclosure is described with reference to an AP. However, a STA or other WLAN device may also perform various aspects of the present disclosure. Accordingly, an AP may initialize and assign channels to the AP's candidate channel list (CCL), e.g., build the AP's CCL by performing channel scans on some channels, determining that certain channels are not associated with frequencies utilized by radar systems, and the like. The AP may assign a channel weighting factor to each channel in the CCL. When the AP detects a radar signal, the AP may identify at least one attribute of the radar signal, e.g., the bandwidth of the radar signal and/or other characteristics of the radar signal. The AP may adjust, based at least in part on the radar signal attribute, the channel weighting factor assigned to a channel of the CCL that is adjacent to the current operating channel. The AP may adjust the channel weighting factor for other channels of the CCL. Generally, the AP may select a new operating channel from the CCL base on the channel's assigned channel weighting factor. The AP may also consider other factors when selecting a new operating channel, e.g., the current or scheduled communication requirements, a radar classification associated with each channel, and the like. Accordingly, the AP may employ a more intelligent channel selection scheme during DFS operations that provides for improved communications.

The following description provides examples, and is not limiting of the scope, applicability, or examples set forth in the claims. Changes may be made in the features and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

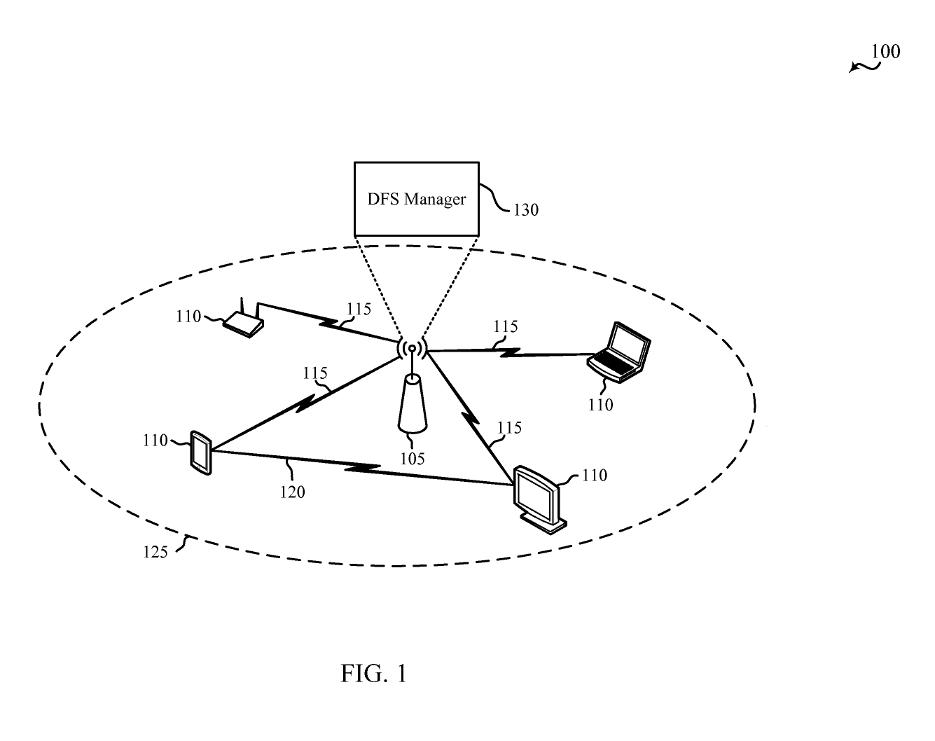

Referring first to FIG. 1, a block diagram illustrates an example of a WLAN 100, e.g., a network implementing at least one from the IEEE 802.11 family of standards. The WLAN 100 includes an AP 105 and wireless devices or STAs 110, e.g., mobile stations, personal digital assistants (PDAs), other handheld devices, netbooks, notebook computers, tablet computers, laptops, display devices (e.g., TVs, computer monitors, etc.), printers, etc. While only one AP 105 is illustrated, the WLAN 100 may have multiple APs. Each of the wireless stations 110, include, e.g., mobile stations (MSs), mobile devices, access terminals (ATs), user equipment (UE), subscriber stations (SSs), or subscriber units, may associate and communicate with an AP 105 via a communication link 115. Each AP 105 has a geographic coverage area 125 such that wireless stations 110 within that area can typically communicate with the AP 105. The wireless stations 110 may be dispersed throughout the geographic coverage area 125. Each wireless station 110 may be stationary or mobile.

Although not shown in FIG. 1, a wireless station 110 can be covered by more than one AP 105 and can therefore associate with APs 105 at different times. A single AP 105 and an associated set of stations may be referred to as a basic service set (BSS). An extended service set (ESS) is a set of connected BSSs. A distribution system (DS) (not shown) is used to connect APs 105 in an extended service set. A geographic coverage area 125 for an access point 105 may be divided into sectors making up only a portion of the coverage area (not shown). The WLAN 100 may include access points 105 of different types (e.g., metropolitan area, home network, etc.), with varying sizes of coverage areas and overlapping coverage areas for different technologies. Although not shown, other wireless devices can communicate with the AP 105.

While the wireless stations 110 communicate with each other through the AP 105 using communication links 115, each wireless station 110 may also communicate directly with other wireless stations 110 via a direct wireless link 120. Two or more wireless stations 110 may communicate via a direct wireless link 120 when both wireless stations 110 are in the AP geographic coverage area 125 or when one or neither wireless station 110 is within the AP geographic coverage area 125 (not shown). Examples of direct wireless links 120 may include Wi-Fi Direct connections, connections established by using a Wi-Fi Tunneled Direct Link Setup (TDLS) link, and other P2P group connections. The wireless stations 110 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within WLAN 100.

AP 105 includes a DFS manager 130 that monitors, controls, or otherwise implements logic, circuits, etc., to perform intelligent channel selection techniques during DFS operations. Generally, the DFS manager 130 controls, determines, or otherwise assigns a channel weighting factor to channels of the CCL. The DFS manager 130, once a radar signal is detected on the current operating channel, identifies an attribute of the radar signal. Example radar signal attributes may include, but are not limited to, a bandwidth which may provide an indication of how many channels the radar signal may cross and therefore interfere with. The DFS manager 130 adjusts, based at least in part on the attribute, the channel weighting factor assigned to a channel of the CCL that is adjacent, e.g., the channel above or the channel below, to the current operating channel. While the AP considers the channel weighting factor when selecting a new operating channel, other factors may also be considered. For example, when the AP has a heavy traffic load, the AP may select a radar-cleared channel having the highest channel weighting factor. As another example when the AP has a light or no current traffic load, the AP may select a non-radar cleared channel having a higher channel weighting factor.

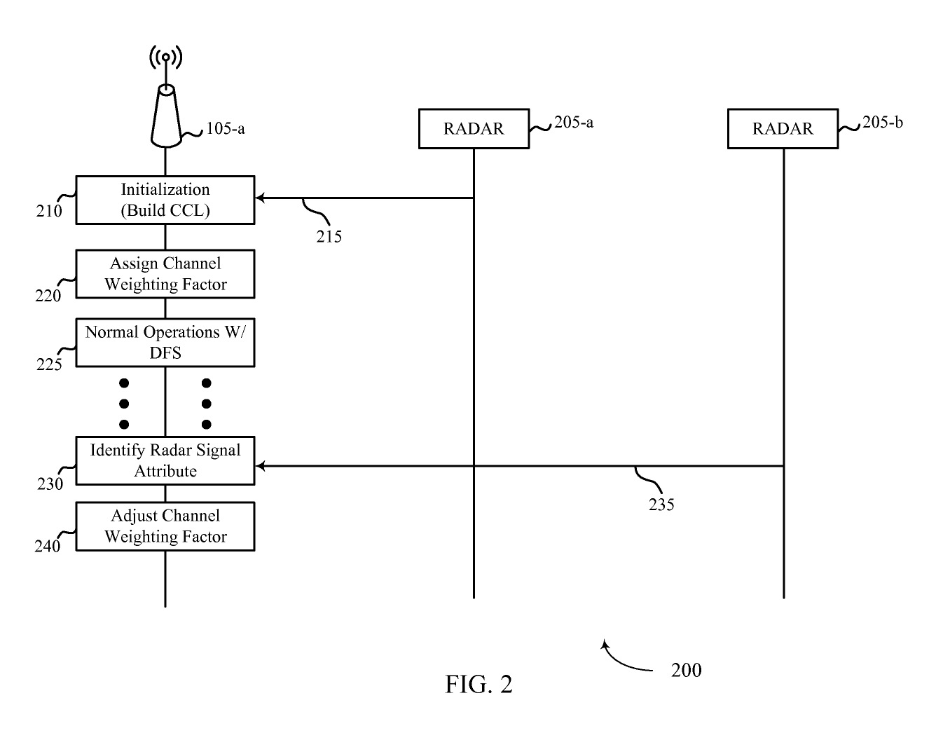

FIG. 2 illustrates an example of a wireless communication 200 between an AP 105-a, a radar 205-a and a radar 205-b in accordance with various aspects of the present disclosure. The AP 105-a may be an example of an AP 105 described with reference to FIG. 1. The radar 205-a and/or the radar 205-b may be an example of any type of known radar systems, e.g., air traffic control radar systems, weather observation radar systems, etc. The AP 105-a may support intelligent channel selection techniques during DFS operations in accordance with various aspects of the present disclosure.

At block 210, the AP 105-a initializes and creates or builds the CCL of AP 105-a. For example, the AP 105-a may be initially powered on, restarted, etc., and therefore initially start with an empty CCL. The AP 105-a may begin to build the CCL by accessing country/region registration codes stored in the AP 105-d, e.g., known a priori and programmed by a manufacturer, distributor, etc. For example, the country/region registration codes may be stored in a regdomain setting and/or downloaded from a network during initialization. The country/region registration codes provide a listing of all channels that the AP 105-a is permitted to communicate using. The listing may also provide an indication of which channels are susceptible to radar interference (e.g., within a particular frequency range) and which channels are not susceptible to radar interference. Generally, the AP 105-a may start by adding all or some of the permitted channels to the CCL of AP 105-a.

AP 105-a then begins to perform channel scanning procedures (e.g., for sixty (60) seconds) to determine whether a radar signal is detected on certain channels. Example channel scanning procedures may include a channel availability check (CAC) to clear channels for use. The AP may perform the CAC procedures on some channels of the CCL, but not necessarily on all permitted channels, e.g., to reduce the channel count on the CCL. In some embodiments, AP 105-a may detect a radar signal 215 transmitted from radar 205-a on a channel during the initialization procedure and assign that channel to a listing that is not available, e.g., a non-occupancy list of channels that cannot be used for communications either permanently or for a minimum time period, e.g., set a non-occupancy flag for the channel for thirty (30) minutes. Radar 205-b may not be transmitting during the initialization period, and therefore AP 105-a may not identify any radar signals associated with radar 205-b.

AP 105-a, upon completing the initialization procedure and building the CCL, assigns certain channels to a radar classifications. For example, channels that are associated with a radar signal that have been cleared may be assigned to a pre-CAC′d radar classification, channels that are associated with a radar signal that have not been CAC′d may be assigned to a non-CAC′d radar classification, and channels that are not associated with a radar signal may be assigned to a non-radar classification.

During the initialization procedures, AP 105-a may optionally also scan channels for a neighboring wireless communication system, e.g., a long-term evolution (LTE) cellular network. When such a system is detected, AP 105-a may add any channels that may interfere with, or be interfered by the LTE network to the non-occupancy list. Accordingly, upon completion of the initialization procedure, AP 105-a may have constructed a CCL list that reflect channels suited, at least to certain extents, for communications.

At block 220, AP 105-a assigns a channel weighting factor to each of the channels of the CCL. Generally, the channel weighting factor assigned to each channel provides an indication of the communication capabilities for the respective channel. Example communication capabilities may include a throughput rate capability for the channel, a bandwidth capability for the channel, a transmit power capability for the channel, a measured signal-to-noise interference (SINR) ratio for the channel, and the like. The communications capabilities for the channel may be associated with a likelihood of interference from a radar signal for the channel. Other communications capabilities for the channel may include a service provider associated with the channel, e.g., a preferred service provider associated with the channel. Other communications capabilities may also be considered in accordance with various aspects of the present disclosure.

At block 225, AP 105-a commences normal operations with any associated DFS operations. For example, AP 105-a may begin communicating with STAs 110 using an operating channel, or a group of operating channels. AP 105-a may also perform channel scanning procedures on other channels of the CCL during normal operations. For example, AP 105-a may perform CAC procedures in a random manner and/or in a predetermined order to ensure that no new radar signal is detected. AP 105-a may confirm, for example, that the radar signal 215 from radar 205-a is still present and therefore the respective channel should continue to be flagged on the non-occupancy list. As long as AP 105-a does not detect any radar signals, normal operations may continue.

During normal operations, AP 105-a maintains a current channel usage history. For example, AP 105-a may maintain a ten (10) to thirty (30) second (or some other time period) rolling usage history for communications. Accordingly, AP 105-a may use the current channel usage history to determine, in the event of a channel change, whether the channel change is associated with a high priority channel change or a low priority channel change. For example, if the recent channel usage indicate that AP 105-a is performing a high traffic load (e.g., streaming video or data, voice communications, high data usage, etc.), a high priority flag may be set. If, however, the recent channel usage indicates that AP 105-a is idle or performing light traffic load, a low priority flag may be set. Accordingly, AP 105-a may maintain a CCL populated with various combinations of a non-radar channels, pre-CAC′d channels, and non-CAC′d channels, wherein each channel may also have an assigned channel weighting factor.

AP 105-a continues normal operations until block 230 where a radar signal 235 is detected from radar 205-b. Radar 205-b may have been activated since the initialization procedure for a variety of reasons, e.g., based at least in part on a schedule or other triggering event. AP 105-a may detect the radar signal 235 and identify at least one attribute of the radar signal. Example attributes may include a bandwidth and/or other signal attributes that may provide an indication of the type of radar signal that was detected and, by extension, other attributes of the radar signal. In one example, the radar signal attribute may provide an indication of whether the radar signal was detected within a single channel (e.g., a 20 MHz channel). This attribute may indicate that the radar signal is associated with a fixed frequency radar system and/or a frequency hopping radar system. In another example, a radar signal attribute may be associated with a chirped radar signal that may spread across a channel. This attribute may be associated with a chirped radar system where the radar signal may spread beyond the current operating channel and into the adjacent channels. A chirped radar signal may be detected across two channels, e.g., the operating channel and one adjacent channel. This attribute may be associated with the radar signal not interfering with other channels of the CCL, e.g., based at least in part on the chirped signal being typically within the bandwidth of two channels. In another example, a radar signal attribute may indicate that the radar signal is a hopping radar system. This radar attribute may be associated with the radar system hopping across other channels, i.e., any of the other channels within the frequency range.

At block 240, AP 105-a adjusts a channel weighting factor for at least one channel of the CCL that is adjacent to the current operating channel. The channel weighting factor for the adjacent channel may be based, at least in certain aspects, on the attribute of the radar signal. For example, if the radar signal attribute indicates the radar signal is detected within a single channel, the channel weighting factor for at least one (or both) channels adjacent to the current operating channel may be lowered. In another example, if the radar signal attribute is detected across a single channel (e.g., a chirped radar signal), the channel weighting factor for at least one (or both) channels adjacent to the current operating channel may be lowered. In another example, if the radar signal attribute is detected across two channels (e.g., a chirped radar signal), the channel weighting factor for at least one (or both) channels adjacent to the current operating channel may not be lowered, i.e., based at least in part on knowledge that the chirped radar signal may not extend beyond the two channels. In another example, if the radar signal attribute indicates that a hopping radar signal is detected, the channel weighting factor for at least one (or both) channels adjacent to the current operating channel may not be lowered, i.e., based at least in part on the knowledge that the hopped radar signal may be present across a variety of channels. If the radar signal attribute is detected across two or more channels, the channel weighting factor for the adjacent channels may not be adjusted, e.g., based at least in part on the knowledge that the radar signal bandwidth may be limited to within two channels.

AP 105-a may select a channel from the CCL based at least in part on the channel weighting factor assigned to the channel. For example, AP 105-a may select a new operating channel assigned the highest channel weighting factor from the CCL. AP 105-a may select a new operating channel assigned the highest channel weighting factor from the radar cleared classification, e.g., channels that are non-radar classification and/or pre-CAC′d channel classification. AP 105-a may select a new operating channel assigned the highest channel weighting factor from the non-radar cleared classification, e.g., channels that have not been pre-CAC′d. For such non pre-CAC′d radar channels, AP 105-a may perform a CAC procedure on the channel prior to commencing operations on the channel.

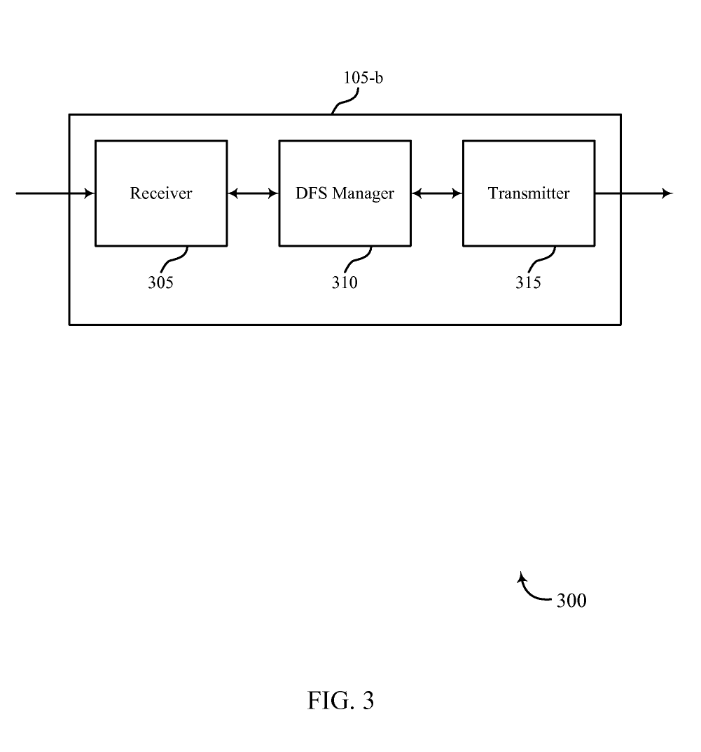

FIG. 3 shows a block diagram 300 of an AP 105-b for wireless communication, in accordance with various aspects of the present disclosure. The AP 105-b may be an example of aspects of an AP 105 described with reference to FIG. 1 or 2. The AP 105-b includes a receiver 305, a DFS manager 310, and/or a transmitter 315. The DFS manager 310 may be an example of the DFS manager 130 described with reference to FIG. 1. The AP 105-b may also be or include a processor (not shown). Each of receiver 305, a DFS manager 310, and/or a transmitter 315 may be in communication with each other.

The AP 105-b, through the receiver 305, the DFS manager 310, and/or the transmitter 315, may be configured to implement features described herein. For example, the AP 105-b may be configured to utilize intelligent channel selection techniques during DFS operations. The AP 105-b may also adjust channel weighting factors for channel(s) of a CCL based at least in part on an attribute of the detected radar signal and may select a channel from the CCL as the new operating channel that has the highest channel weighting factor, is associated with a particular channel change priority metric, and/or is assigned to a particular radar classification.

The components of the AP 105-b may, individually or collectively, be implemented using application-specific integrated circuits (ASICs) adapted to implement some or all of the applicable features in hardware. Alternatively, the features may be implemented by other processing units (or cores), on integrated circuits. Other types of integrated circuits may be used (e.g., Structured/Platform ASICs, Field Programmable Gate Arrays (FPGAs), and other Semi-Custom ICs), which may be programmed in any manner known in the art. The features of each component may also be implemented, in whole or in part, with instructions embodied in a memory, formatted to be executed by general or application-specific processors.

The receiver 305 receives information such as packets, user data, and/or control information associated with various information channels (e.g., control channels, data channels, etc.). The receiver 305 may be configured to receive transmissions associated with intelligent channel selections during DFS operations. Information may be passed on to the DFS manager 310, and to other components of the AP 105-b.

The DFS manager 310 monitors, controls, or otherwise manages aspects of intelligent channel selection during DFS operations for the AP 105-b. For example, the DFS manager 310 may assign a channel weighting factor to each channel in a CCL. Generally, the channel weighting factor may provide an indication of the suitability of the channel for communications based at least in part on the channel conditions, likelihood of interference, etc. The DFS manager 310 can identify an attribute of a radar signal detected on a current operating channel. The radar signal attribute may be associated with whether the detected radar signal is contained within the current operating channel, is spread across the current operating channel, and/or is spread across the current operating channel and at least one other channel. The DFS manager 310 adjusts, based at least in part on the radar signal attribute, the channel weighting factor assigned to a channel of the CCL that is adjacent to the current operating channel. For example, if the radar signal attribute indicates that the radar signal may interfere with the adjacent channel, the channel weighting factor for the adjacent channel(s) may be lowered to reduce the likelihood that they would be selected as the new operating channel.

The transmitter 315 may transmit the signal(s) received from other components of the AP 105-b. The transmitter 315 may transmit various transmissions associated with intelligent channel selection during DFS operations for the AP 105-b. The transmitter 315 may be collocated with the receiver 305 in a transceiver.

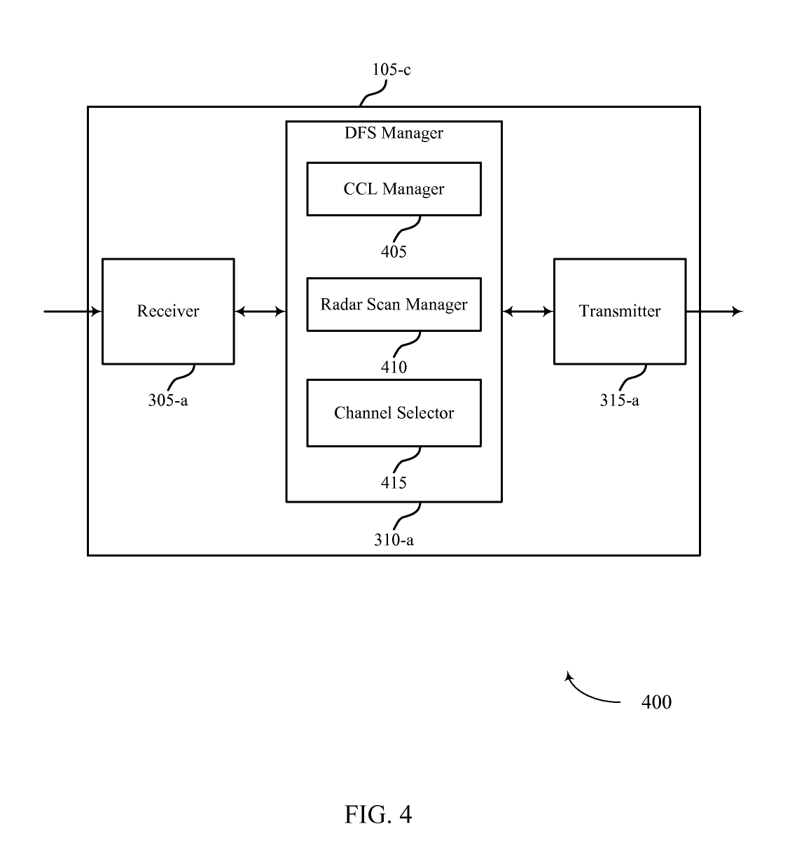

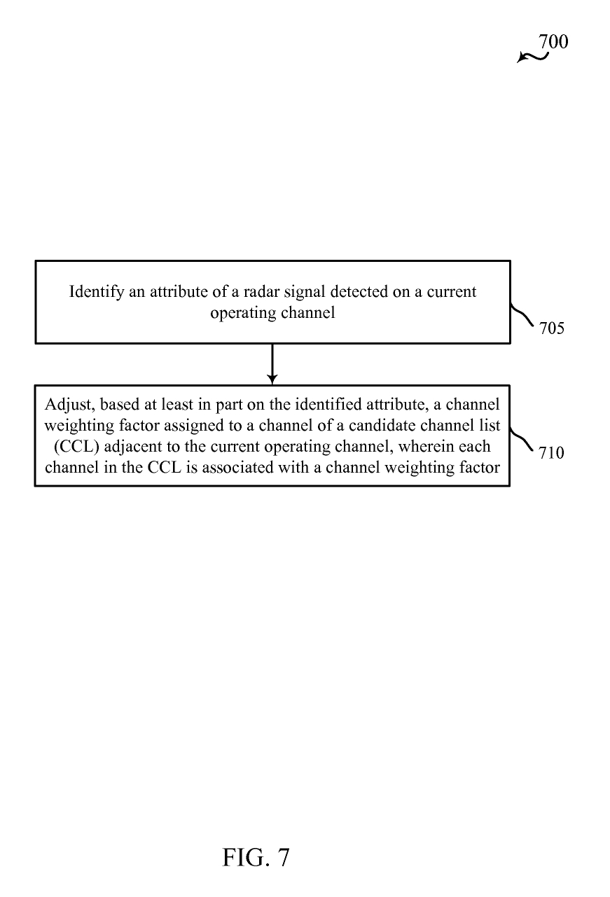

FIG. 4 shows a block diagram 400 of an AP 105-c that is used for wireless communication, in accordance with various examples. The AP 105-c may be an example of aspects of APs 105 described with reference to FIGS. 1-3. The AP 105-c includes a receiver 305-a, a DFS manager 310-a, and/or a transmitter 315-a, which may be examples of the corresponding components of AP 105-b. The AP 105-c may also include a processor (not shown). Each of these receiver 305-a, a DFS manager 310-a, and/or a transmitter 315-a may be in communication with each other. The DFS manager 310-a may include a CCL manager 405, a radar scan manager 410, and/or a channel selector 415. The receiver 305-a and the transmitter 315-a may implement the features of the receiver 305 and the transmitter 315 of FIG. 7, respectively.

The CCL manager 405 monitors, controls, or otherwise manages aspects of the CCL for the AP 105-c. For example, the CCL manager 405 may manage aspects of constructing the CCL once the AP 105-c is initialized. Moreover, the CCL manager 405 may manage aspects of updating the CCL during normal operations (e.g., based at least in part on continuous scanning procedures conducted during normal communications) and/or during DFS operations (e.g., maintaining a non-occupancy list, adjusting channel weighting factors for the channels assigned to the CCL, etc.).

The CCL manager 405 may assign a channel weighting factor to each channel of the CCL. As discussed above, the channel weighting factor may provide an indication of the suitability of the channel to be selected as a new operating channel, e.g., during DFS operations. The channel weighting factor may be associated with a scale or range of numbers where a higher channel weighting factor may indicate that the channel is more ideally suited for selection, with respect to a channel having a lower channel weighting factor.

The CCL manager 405 may manage aspects of adjusting the channel weighting factors assigned to the channels of the CCL. For example, during routine scanning procedures various attributes of a channel may change, e.g., SINR may rise or lower. Accordingly, as the channel weighting factor may be related to the capabilities of the channel, the channel weighting factor may be raised or lowered accordingly. The CCL manager 405 may also, alone or in cooperation with other components of the AP 105-c, adjust the channel weighting factor based at least in part on the attributes of a radar signal detected during DFS operations.

The radar scan manager 410 may monitor, control, or otherwise manage aspects of scanning for radar signals for the AP 105-c. For example, the radar scan manager 410 may scan for radar signals during normal operations, e.g., using receive chain(s) available for scanning. The AP 105-c may scan for radar signals on certain channels periodically according to a known schedule and/or may scan for radar signals during idle periods where receivers are available.

When a radar signal is detected on the current operating channel, the radar scan manager 410 may manage aspects of identifying an attribute of the detected radar signal. For example, the radar scan manager 410 may monitor or measure frequency component(s) and/or a time component(s) of the radar signal to determine the radar signal attribute. The radar scan manager 410 may perform a Fast-Fourier transform (FFT) on the detected radar signal to determine the radar signal attribute.

The radar scan manager 410 may output information indicative of, or associated with the radar signal attribute to other components of the AP 105-c. For example, the radar scan manager 410 may output information to the CCL manager 405 indicative of the identified radar signal attribute. In response, the CCL manager 405 may adjust a channel weighting factor for channel(s) adjacent to the current operating channel (e.g., channel above and/or channel below) based at least in part on the radar signal attribute.

The radar scan manager 410 may identify a bandwidth of the detected radar signal and output information to the CCL manager 405 indicative of the bandwidth. The CCL manager 405 may determine that the bandwidth of the detected radar signal spans the current operating channel and at least portions of an adjacent channel and, accordingly, refrain from adjusting the channel weighting factor for the adjacent channel. For example, if the detected radar signal occupies more than one channel bandwidth, it may not be helpful to adjust the channel weighting factors for adjacent channels based at least in part on a priori knowledge that the type of radar system (e.g., determined based at least in part on the radar signal attribute) is associated with a bandwidth spanning only the two channels (e.g., current operating channel and one adjacent channel). The CCL manager 405 may determine that the bandwidth of the detected radar signal may be contained within the bandwidth of the current operating channel and, accordingly, adjust the channel weighting factor for an adjacent channel above or below the current operating channel.

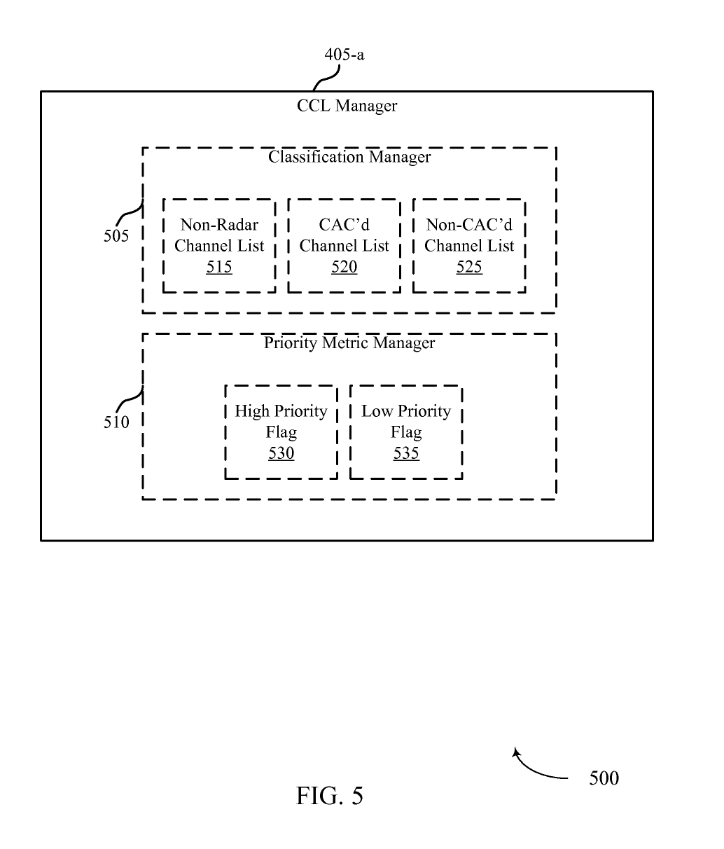

The channel selector 415 may monitor, control, or otherwise manage aspects of selecting a new operating channel for the AP 105-c. For example, the channel selector 415 may access the CCL manager 405 to determine the channel weighting factors for the channels of the CCL and select a new operating channel based at least in part on the assigned channel weighting factor. The channel selector 415 may select the new operating channel and provide information to the receiver 305-a and/or the transmitter 315-a indicative of the selected operating channel. Additional aspects of the channel selector 415 will be described below in conjunction with the CCL manager 405-a of FIG. 5.

FIG. 5 shows a block diagram 500 of an example of a CCL manager 405-a that is used for wireless communication, in accordance with various examples. The CCL manager 405-a may be an example of aspects of the CCL manager 405 described with reference to FIG. 4. The CCL manager 405-a includes a classification manager 505 and/or a priority metric manager 510. The CCL manager 405-a may also include a processor (not shown). Each of CCL manager 405-a, classification manager 505, and/or priority metric manager 510 may be in communication with each other. Generally, the CCL manager 405-a may store additional information, i.e., in addition to the channel weighting factor, for each or some of the channels of the CCL that may provide additional considerations when selecting a new operating channel.

The classification manager 505 may include a non-radar channel list 515, a CAC′d channel list 520, and a non-CAC′d channel list 525. Generally, the classification manager 505 may assign or associate each channel in the CCL to a radar classification. The radar classification may include a radar cleared classification or a non-radar cleared classification. As discussed above, only a portion of the authorized channels may be associated with radar signals, e.g., may be within a frequency range typically associated with radar system use. Channels that are not associated with radar signals, e.g., those outside the frequency range of radar systems, may be assigned to or associated with the non-radar channel list 515. The non-radar channel list 515 may be considered a radar cleared classification.

Moreover, a CAC procedure may be performed on channels that are associated with radar signals to clear the channels for operations. The CAC procedure may include a ten (10) second, a thirty (30) second, a sixty (60) second, or some other time period scan on the channel to detect for a radar signal. The CAC procedure may be performed once upon initialization and then repeated randomly and/or according to a fixed schedule. Once a channel has been cleared for use using the CAC procedure (e.g., CAC′d), the channel may be assigned to or associated with the CAC′d channel list 520. The CAC′d channel list 520 may be considered a radar cleared classification.

Certain channels that are associated with radar signals may not have been cleared for use using a CAC procedure (e.g., non-CAC′d). For example, channels that are associated with radar signals may be added to the CCL, but a CAC procedure (e.g., a full sixty (60) second scan) may not have been performed on the channel. Other aspects of the channel may have been determined, e.g., various channel capability metrics, such that a channel weighting factor can be assigned to the channel. Channels that are associated with radar signals (e.g., are within the frequency range of radar systems) that have not been CAC′d or have not been CAC′d within a certain time frame may be assigned to the non-CAC′d channel list 525. The non-CAC′d channel list 525 may be considered a non-radar cleared classification.

Accordingly, the CCL manager 405-a may maintain, for each channel of the CCL, information associated with whether the channel is radar cleared (e.g., on the non-radar channel list 515 and/or the CAC′d channel list 520) or is non-radar cleared (e.g., on the non-CAC′d channel list 525). It is to be understood that not every channel list may have channels assigned. For example, in some environments the CCL may have no channels assigned to or associated with a radar cleared classification. In some environments, the CCL may have no channels assigned to or associated with a non-radar cleared classification. Therefore, the non-radar channel list 515, the CAC′d channel list 520, and/or the non-CAC′d channel list 525 may each have all, some, or no channels assigned at any particular time.

The priority metric manager 510 may include a high priority flag 530 and/or a low priority flag 535. Generally, the priority metric manager 510 may identify a priority metric associated with the channel change between channels of the CCL. The channel change may be based, at least in certain aspects, on the radar classification. The priority metric manager 510 may be identified based at least in part on a rolling history of current channel usage history. For example, AP 105-c may maintain a ten (10) to thirty (30) second (or some other time period) rolling usage history for communications on the current operating channel(s). Accordingly, priority metric manager 510 may use the current channel usage history to determine, in the event of a channel change, whether the channel change is associated with a high priority channel change or a low priority channel change. For example, if the recent channel usage indicates that AP 105-c is performing a high traffic load (e.g., streaming video or data, voice communications, high data usage, etc.), the high priority flag 530 may be set, e.g., changed from “0” to “1,” or vice versa. If, however, the recent channel usage indicates that AP 105-c is idle or performing light traffic load, the low priority flag 535 may be set. The high priority flag 530 and the low priority flag 535 may be combined in a single flag or information element (IE) where the current state of the flag indicates whether the channel change is associated with a high priority (e.g., “1”) or a low priority (e.g., “0”).

Returning now to the description of the features of the channel selector 415 of FIG. 4 in connection with the CCL manager 405-a, the channel selector 415 may utilize aspects of the classification manager 505 and/or the priority metric manager 510, in conjunction with the channel weighting factor assigned to the channels, when selecting a new operating channel. The channel selector 415 may access the CCL manager 405-a and determine that the priority metric associated with the channel change is a first priority metric (e.g., a high priority metric where the high priority flag 530 is set). The channel selector 415 may identify channels with a radar cleared classification (e.g., access the non-radar channel list 515 and/or the CAC′d channel list 520) and select a channel having the highest channel weighting factor as the new operating channel. Selecting a channel from the radar cleared classification when the channel change priority is high may permit the high traffic load to continue with minimal or no interruption.

The channel selector 415 may access the CCL manager 405-a and determine that the priority metric associated with the channel change is a first priority metric (e.g., a high priority metric where the high priority flag 530 is set). The channel selector 415 may determine that there are no channels with a radar cleared classification (e.g., the non-radar channel list 515 and the CAC′d channel list 520 are both empty) and therefore access channels associated with a non-radar cleared classification (e.g., access the non-CAC′d channel list 525). The channel selector 415 may select a channel having the highest channel weighting factor from the non-CAC′d channel list 525 as the new operating channel. The channel selector 415 may, however, perform a scan procedure on the new operating channel prior to communicating on the new operating channel, e.g., a CAC scan procedure to clear the channel.

The channel selector 415 may access the CCL manager 405-a and determine that the priority metric associated with the channel change is a second priority metric (e.g., a low priority metric where the low priority flag 535 is set). The channel selector 415 may identify a first channel assigned to a radar cleared classification (e.g., from the non-radar channel list 515 or the CAC′d channel list 520) and a second channel assigned to a non-radar cleared classification (e.g., from the non-CAC′d channel list 525). The channel selector 415 may select a channel having the highest channel weighting factor from the non-radar cleared classification as the new operating channel based, at least in certain aspects, on the difference between the channel weighting factor of the second channel and the channel weighting factor of the first channel exceeds a predetermined threshold. The predetermined threshold may be set to provide a minimal level of channel capability advantage for the second channel over the first channel. For example, the channel weighting factor for the second channel may indicate that the second channel has greater channel capability characteristics with respect to the first channel, e.g., higher bandwidth, higher throughput capability, lower noise interference, etc. Accordingly, the channel selector 415 may determine that, given the low channel change priority, the second channel may be a better channel to select as the new operating channel even in view of the second channel being assigned to the non-radar cleared classification. The AP 105-c may perform a scan procedure on the second channel prior to communicating on the second channel. The channel selector 415 may select the first channel when the different between the channel weighting factor of the first channel and the channel weighting factor of the second channel is below the predetermined threshold.

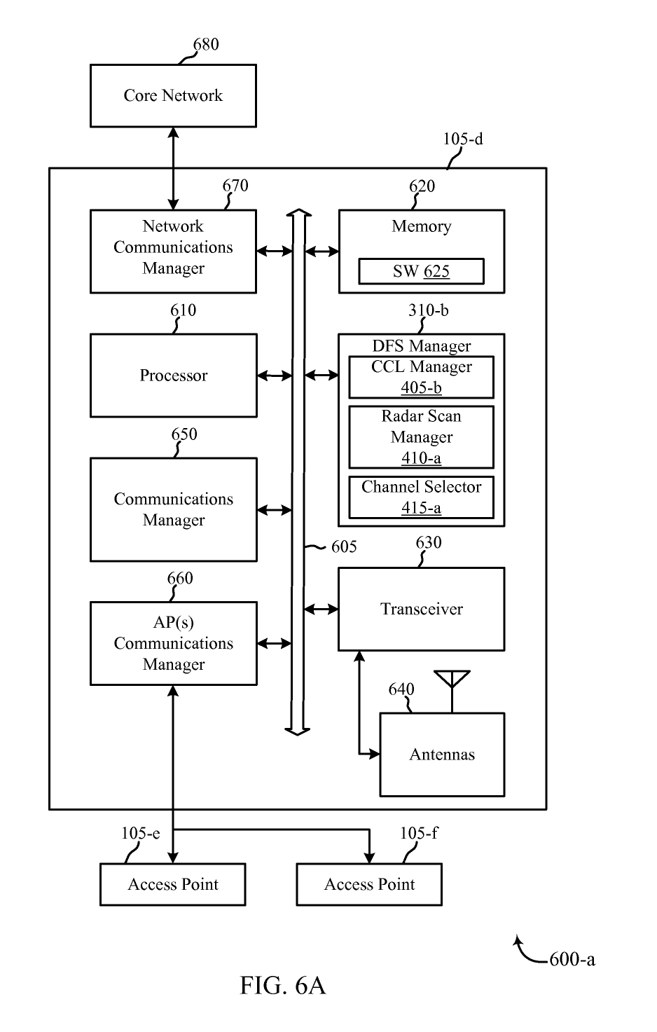

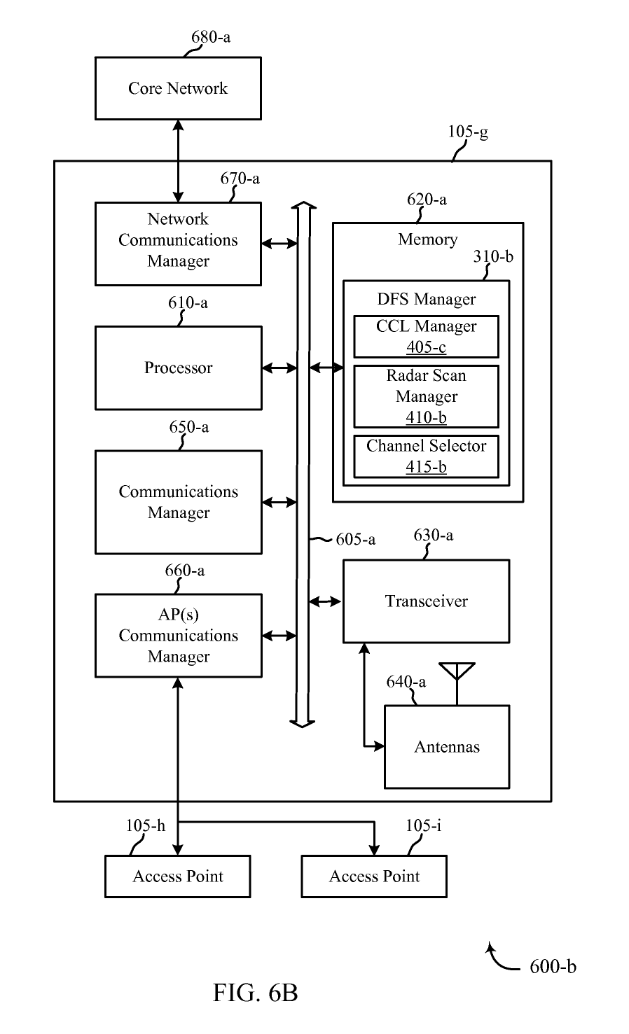

FIG. 6A shows a block diagram of a system 600-a including AP 105-d configured for intelligent DFS operations, a plurality of APs 105-e, 105-f, and a core network 680, in accordance with various aspects of the present disclosure. AP 105-d may be an example of an AP 105 described with reference to FIGS. 1-5. AP 105-d may include a DFS manager 310-b, which may be an example of the DFS manager 310 as described with reference to FIGS. 1 and 3-5. The DFS manager 310-b may implement the features described above with reference to FIG. 2.

The components of the AP 105-d may, individually or collectively, be implemented with at least one ASIC adapted to implement some or all of the applicable features in hardware. Alternatively, the features may be implemented by other processing units (or cores), on at least one IC. In other embodiments, other types of integrated circuits may be used (e.g., Structured/Platform ASICs, an FPGA, or another semi-custom IC), which may be programmed in any manner known in the art. The features of each unit may also be implemented, in whole or in part, with instructions embodied in a memory, formatted to be executed by general or application-specific processors.

AP 105-d may also have wired backhaul links AP 105-d may have a wired backhaul link (e.g., 51 interface, etc.) to the core network 680. AP 105-d may also communicate with other base stations 105-e and 105-f via inter-base station backhaul links. Each of the APs 105 may communicate with STAs 110 using the same or different wireless communications technologies. AP 105-d may also communicate with other APs utilizing AP communications manager 660. AP communications manager 660 may provide an X2 interface within an LTE/LTE-A wireless communication network technology to provide communication between some of the APs 105. AP 105-d may also communicate with the core network 680 through network communications manager 670.

AP 105-d includes a processor 610, memory 620 (including software (SW) 625), transceiver(s) 630, and antenna(s) 640, which each may be in communication, directly or indirectly, with one another (e.g., over a bus 605). The transceiver(s) 630 may be configured to communicate bi-directionally, via the antenna(s) 640, with STAs 110, which may be wireless stations. The transceiver(s) 630 (or other components of AP 105-d) may also be configured to communicate bi-directionally, via the antenna(s) 640, with other APs 105-e and 105-f. The transceiver(s) 630 may include a modem configured to modulate the packets and provide the modulated packets to the antennas 640 for transmission, and to demodulate packets received from the antennas 640. AP 105-d may include multiple transceivers 630, each with associated antennas 640. The transceiver(s) may be an example of a combination of receiver 305 and transmitter 315 of FIGS. 3 and 4.

The memory 620 may include RAM and ROM. The memory 620 may also store computer-readable, computer-executable software code 625 containing instructions that are configured to, when executed, cause the processor 610 to implement various features described herein (e.g., channel selection techniques for DFS operations, etc.). Alternatively, the computer-executable software code 625 may not be directly executable by the processor 610 but be configured to cause (e.g., when compiled and executed) a computer to implement features described herein. The processor 610 may include an intelligent hardware device (e.g., a CPU, a microcontroller, an ASIC, etc.). The processor 610 may include various special purpose processors such as encoders, queue processing modules, base band processors, radio head controllers, DSPs, and the like.

The AP communications manager 660 manages communications with other APs 105, e.g., APs 105-e and 105-f. The AP communications manager 660 may include a controller or scheduler for controlling communications with STAs 110 in cooperation with other APs 105. For example, the AP communications manager 660 may coordinate scheduling for transmissions to STAs 110 for various transmission types and on different channels.

The DFS manager 310-b may be configured to perform and/or control some or all of the features described with reference to FIGS. 1-5 related to intelligent channel selection and reporting operations for the AP 105-d. The DFS manager 310-b may assign a channel weighting factor to each channel in a CCL, identify an attribute of a radar signal detected on a current operating channel, and adjust, based at least in part on the attribute, the channel weighting factor assigned to a channel of the CCL that is adjacent to the current operating channel. The DFS manager 310-b, or portions thereof, may include a processor, and/or some or all of the features of the DFS manager 310-b may be implemented by the processor 610 and/or in connection with the processor 610. The DFS manager 310-b may be an example of the DFS manager 310 described with reference to FIGS. 3-5. For example, the DFS manager 310-b may include a CCL manager 405-b, a radar scan manager 410-a, and/or a channel selector 415-a, which may be examples of and implement the features of the CCL manager 405, the radar scan manager 410, and/or the channel selector 415, respectively, described with reference to FIGS. 4 and 5.

FIG. 6B shows a block diagram of a system 600-b including AP 105-g configured for wireless communications, in accordance with various aspects of the present disclosure. AP 105-g may be an example of an AP 105 described with reference to FIGS. 1-5, or an example of AP 105-d described with reference to FIG. 6A.

AP 105-g includes a processor 610-a, memory 620-a, transceiver 630-a, antenna(s) 640-a, communications manager 650-a, AP(s) communications manager 660-a, and network communications manager 670-a, each of which may implement the features described above with reference to FIG. 6A. In the present example, the memory 620-a may include software that implements the features of DFS manager 310-c. For example, memory 620-a may include software that, when compiled and executed, implement the features of the CCL manager 405, the radar scan manager 410, and/or the channel selector 415, respectively, described with reference to FIGS. 4, 5, and 6A. A subset of the features of DFS manager 310-c is included in memory 620-a; in other cases, all of the features may be implemented as software executed by the processor 610-a to cause the AP 105-g to implement the features of DFS manager 310-c. For example, the features of the CCL manager 405 and/or the radar scan manager 410 may be implemented by software included memory 620-a, while the features of the channel selector 415 may be implemented using hardware. Other combinations of hardware/software to implement the features of DFS manager 310-c may be used.

FIG. 7 is a flowchart illustrating another example of a method 700 for wireless communication, in accordance with various aspects of the present disclosure. The method 700 may be performed in accordance with aspects of the AP 105 described with reference to FIGS. 1-6B. For the sake of clarity, the method 700 is described with respect to an AP. The DFS manager 130 or 310 described with reference to FIGS. 1 and 3-6B implements aspects of the method 700.

At block 705, the method 700 may include the AP identifying an attribute of a radar signal detected on a current operating channel. For example, the AP may perform FFT processing of the detected radar signal and/or determine various frequency or time parameters of the radar signal to identify the attribute. The attribute may be a bandwidth of the detected radar signal.

At block 710, the method 700 may include the AP adjusting, based at least in part on the identified attribute, a channel weighting factor assigned to a channel of a candidate channel list (CCL_adjacent to the current operating channel, wherein each channel in the CCL is associated with a channel weighting factor. For example, the AP may adjust the channel weighting factor for a channel above the current operating channel and/or the channel weighting factor for a channel below the current operating channel. The AP may adjust the channel weighting factor of the adjacent channel based at least in part on a bandwidth of the detected radar signal.

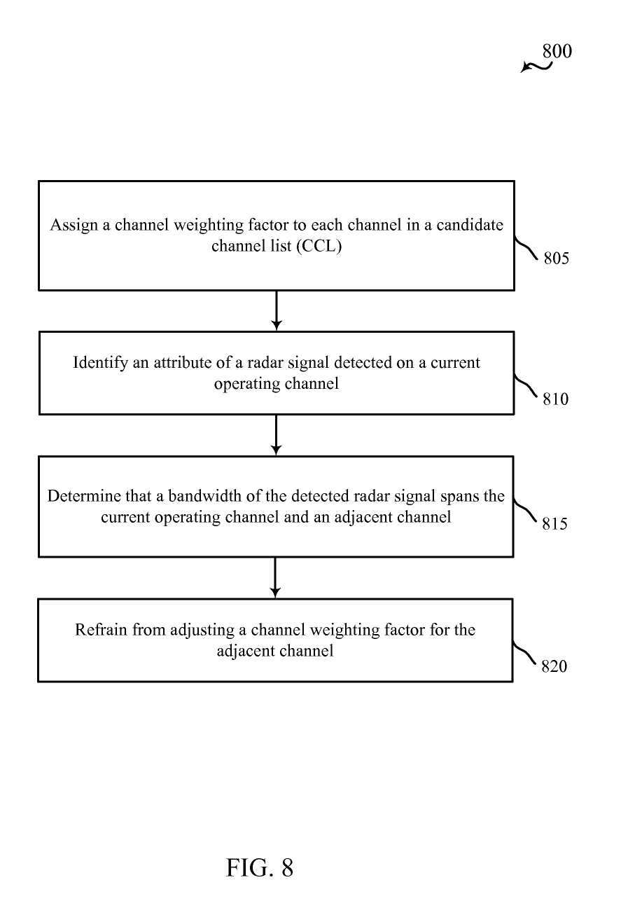

FIG. 8 is a flowchart illustrating another example of a method 800 for wireless communication, in accordance with various aspects of the present disclosure. The method 800 may be performed in accordance with aspects of the AP 105 described with reference to FIGS. 1-6B. For the sake of clarity, the method 800 is described with respect to an AP. The DFS manager 130 or 310 described with reference to FIGS. 1 and 3-6B implements aspects of the method 800. The method 800 may also incorporate aspects of method 700 of FIG. 7.

At block 805, the method 800 may include the AP assigning a channel weighting factor to each channel in a CCL. For instance, the AP may construct the CCL during initialization procedures and/or update the CCL during normal operating procedures. The channel weighting factor may provide an indication of the suitability of the channel as a new operating channel during DFS operations.

At block 810, the method 800 may include the AP identifying an attribute of a radar signal detected on a current operating channel. For example, the AP may perform FFT processing of the detected radar signal and/or determine various frequency or time parameters of the radar signal to identify the attribute. The attribute may be a bandwidth of the detected radar signal.

At block 815, the method 800 may include the AP determining that a bandwidth of the detected radar signal spans the current operating channel and an adjacent channel. For example, the attribute of the detected radar signal may indicate or otherwise suggest that the radar signal may cause interference with the current operating channel and at least one adjacent channel, e.g., the channel above or the channel below the current operating channel.

At block 820, the method 800 may include the AP refraining from adjusting, based at least in part on the bandwidth, the channel weighting factor assigned to the adjacent channel. For example, the AP may determine that due to the radar signal likely causing interference in the adjacent channel, the AP may not adjust the channel weighting factor for the adjacent channel. The AP may, instead, add the adjacent channel to the non-occupancy list such that the adjacent channel may not be used for communications for a predetermined time period.

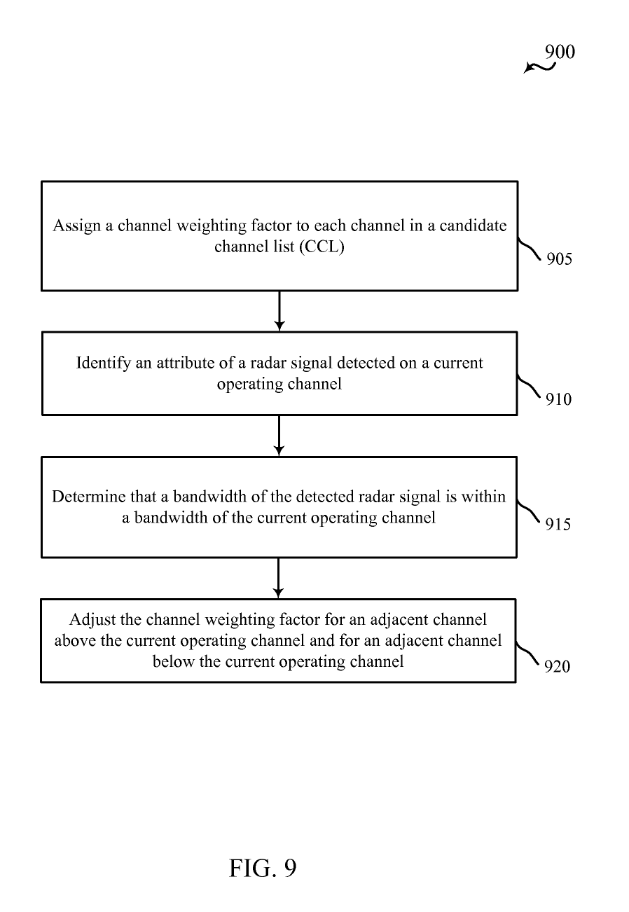

FIG. 9 is a flowchart illustrating another example of a method 900 for wireless communication, in accordance with various aspects of the present disclosure. The method 900 may be performed in accordance with aspects of the AP 105 described with reference to FIGS. 1-6B. For the sake of clarity, the method 900 is described with respect to an AP. The DFS manager 130 or 310 described with reference to FIGS. 1 and 3-6B implements aspects of the method 900. The method 900 may also incorporate aspects of method 700 of FIG. 7 and method 800 of FIG. 8.

At block 905, the method 900 may include the AP assigning a channel weighting factor to each channel in a CCL. For instance, the AP may construct the CCL during initialization procedures and/or update the CCL during normal operating procedures. The channel weighting factor may provide an indication of the suitability of the channel as a new operating channel during DFS operations.

At block 910, the method 900 may include the AP identifying an attribute of a radar signal detected on a current operating channel. For example, the AP may perform FFT processing of the detected radar signal and/or determine various frequency or time parameters of the radar signal to identify the attribute. The attribute may be a bandwidth of the detected radar signal.

At block 915, the method 900 may include the AP determining that a bandwidth of the detected radar signal is within the current operating channel. For example, the attribute of the detected radar signal may indicate or otherwise suggest that the radar signal may cause interference with the current operating channel, but may not cause interference in any adjacent channel, e.g., the channel above or the channel below the current operating channel.

At block 920, the method 900 may include the AP adjusting, based at least in part on the bandwidth, the channel weighting factor assigned to an adjacent channel. For example, the AP may determine that due to interference caused by the radar signal likely being contained within the operating channel, the AP may adjust the channel weighting factor for an adjacent channel. The AP may lower the channel weighting factor for the adjacent channel to reduce the chance that the adjacent channel may be selected as the new operating channel during DFS operations.

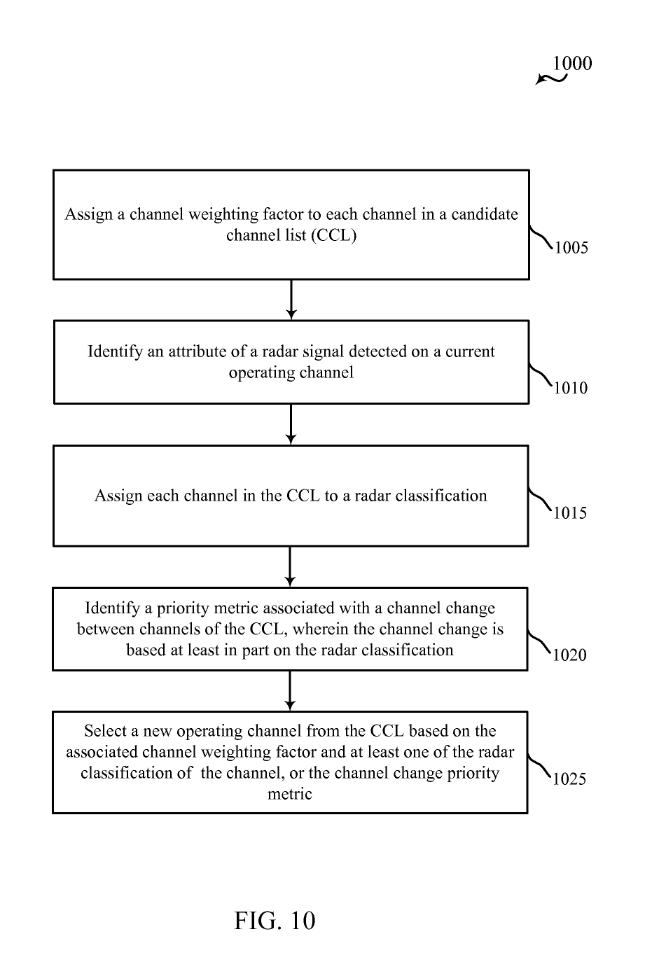

FIG. 10 is a flowchart illustrating another example of a method 1000 for wireless communication, in accordance with various aspects of the present disclosure. The method 1000 may be performed in accordance with aspects of the AP 105 described with reference to FIGS. 1-6B. For the sake of clarity, the method 1000 is described with respect to an AP. The DFS manager 130 or 310 described with reference to FIGS. 1 and 3-6B implements aspects of the method 1000. The method 1000 may also incorporate aspects of method 700 of FIG. 7, method 800 of FIG. 8, and method 900 of FIG. 9.

At block 1005, the method 1000 may include the AP assigning a channel weighting factor to each channel in a CCL. For instance, the AP may construct the CCL during initialization procedures and/or update the CCL during normal operating procedures. The channel weighting factor may provide an indication of the suitability of the channel as a new operating channel during DFS operations.

At block 1010, the method 1000 may include the AP identifying an attribute of a radar signal detected on a current operating channel. For example, the AP may perform FFT processing of the detected radar signal and/or determine various frequency or time parameters of the radar signal to identify the attribute. The attribute may be a bandwidth of the detected radar signal.

At block 1015, the method 1000 may include the AP assigning each channel in the CCL to a radar classification. For example, the AP may assign the channels to a radar cleared classification or to a non-radar cleared classification. Examples of a radar cleared classification may include a non-radar channel list and/or a CAC′d channel list. An example of a non-radar cleared classification may include a non-CAC′d channel list.

At block 1020, the method 1000 may include the AP identifying a priority metric associated with a channel change between channels of the CCL. The channel change may be based at least in part on the radar classification. The priority metric may be associated with a rolling traffic load usage metric such that a high traffic load may have a first priority metric and a low traffic load may have a second priority metric.

At block 1025, the method 1000 may include the AP selecting a new operating channel from the CCL based at least in part on the associated channel weighting factor and at least the radar classification and/or the channel change priority metric. For example, the AP may select a new operating channel from the channel having the highest channel weighting factor, from the channel having the highest channel weighting factor within a particular radar classification, and the like.

Thus, methods 700, 800, 900, and 1000 may provide methods for wireless communication. It should be noted that methods 700, 800, 900, and 1000 describe possible implementation, and that the operations and the steps may be rearranged or otherwise modified such that other implementations are possible. Aspects from two or more of the methods 700, 800, 900, and 1000 are combinable.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the features described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, microprocessors in conjunction with a DSP core, or any other such configuration.

The features described herein may be implemented in hardware, software executed by a processor, firmware, or any combination thereof. If implemented in software executed by a processor, the features are stored on or transmitted over as instructions or code on a computer-readable medium. Other examples and implementations are within the scope and spirit of the disclosure and appended claims. For example, due to the nature of software, features described above can be implemented using software executed by a processor, hardware, firmware, hardwiring, or combinations of any of these. Features may also be physically located at various positions, including being distributed such that portions of features are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
identifying an attribute of a radar signal detected on a current operating channel; and
adjusting, based at least in part on the identified attribute, a channel weighting factor assigned to a channel of a candidate channel list (CCL) adjacent to the current operating channel, wherein each channel in the CCL is associated with a channel weighting factor.

2. The method of claim 1, further comprising:
selecting a new operating channel from the CCL based at least in part on the adjusted channel weighting factor.

3. The method of claim 1, further comprising:
identifying a priority metric associated with a channel change between channels of the CCL, wherein the channel change is based at least in part on a radar classification for the channel in the CCL.

4. The method of claim 3, wherein the radar classification comprises a radar cleared classification.

5. The method of claim 4, further comprising:
determining that the priority metric associated with the channel change is a first priority metric; and
selecting a new operating channel from the channels assigned to the radar cleared classification and having a highest channel weighting factor.

6. The method of claim 3, wherein the radar classification comprises a non-radar cleared classification.

7. The method of claim 6, further comprising:
determining that the priority metric associated with the channel change is a first priority metric;
failing to identify a channel assigned to a radar cleared classification;
selecting a new operating channel from the channels assigned to the non-radar cleared classification and having a highest channel weighting factor; and
performing a scan procedure on the new operating channel prior to communicating on the new operating channel.

8. The method of claim 3, further comprising:
determining that the priority metric associated with the channel change is a second priority metric;
identifying a first channel assigned to a radar cleared classification and having a first highest channel weighting factor;
identifying a second channel assigned to a non-radar cleared classification and having a second highest channel weighting factor; and
selecting a new operating channel from a group consisting of the first channel and the second channel, wherein the second channel is selected based at least in part on a difference between the channel weighting factor of the second channel and the channel weighting factor of the first channel exceeding a predetermined threshold, and wherein the first channel is selected based at least in part on a difference between the channel weighting factor of the first channel and the channel weighting factor of the second channel being below a predetermined threshold.

9. The method of claim 8, further comprising:
performing a scan procedure on the second channel prior to communicating on the second channel.

10. The method of claim 1, wherein the attribute of the detected radar signal is a bandwidth of the detected radar signal.

11. The method of claim 10, further comprising:
determining that the bandwidth of the detected radar signal spans the current operating channel and an adjacent channel; and
refraining from adjusting the channel weighting factor for the adjacent channel.

12. The method of claim 10, further comprising:
determining that the bandwidth of the detected radar signal is within a bandwidth of the current operating channel; and
adjusting the channel weighting factor for an adjacent channel above the current operating channel and for an adjacent channel below the current operating channel.

13. A device for wireless communication, comprising:
a radar scan manager to identify an attribute of a radar signal detected on a current operating channel; and
a channel selector to adjust, based at least in part on the identified attribute, a channel weighting factor assigned to a channel of a candidate channel list (CCL) adjacent to the current operating channel, wherein each channel in the CCL is associated with a channel weighting factor.

14. The device of claim 13, further comprising:
selecting a new operating channel from the CCL based at least in part on the adjusted channel weighting factor.

15. The device of claim 13, wherein the CCL manager is further to identify a priority metric associated with a channel change between channels of the CCL, wherein the channel change is based at least in part on a radar classification for the channel in the CCL.

16. The device of claim 15, wherein the radar classification comprises a radar cleared classification.

17. The device of claim 16, wherein the CCL manager is further to determine that the priority metric associated with the channel change is a first priority metric; and
wherein the channel selector is further to select a new operating channel from the channels assigned to the radar cleared classification and having a highest channel weighting factor.

18. The device of claim 15, wherein the radar classification comprises a non-radar cleared classification.

19. The device of claim 18, wherein the CCL manager is further to determine that the priority metric associated with the channel change is a first priority metric;
wherein the CCL manager is further to fail to identify a channel assigned to a radar cleared classification;
wherein the channel selector is further to select a new operating channel from the channels assigned to the non-radar cleared classification and having a highest channel weighting factor; and
wherein the CCL manager is further to perform a scan procedure on the new operating channel prior to communicating on the new operating channel.

20. The device of claim 15, wherein the CCL manager is further to determine that the priority metric associated with the channel change is a second priority metric;
wherein the CCL manager is further to identify a first channel assigned to a radar cleared classification and having a first highest channel weighting factor;
wherein the CCL manager is further to identify a second channel assigned to a non-radar cleared classification and having a second highest channel weighting factor; and
wherein the channel selector is further to select a new operating channel from a group consisting of the first channel and the second channel, wherein the second channel is selected based at least in part on a difference between the channel weighting factor of the second channel and the channel weighting factor of the first channel exceeding a predetermined threshold, and wherein the first channel is selected based at least in part on a difference between the channel weighting factor of the first channel and the channel weighting factor of the second channel being below a predetermined threshold.

21. The device of claim 20, wherein the CCL manager is further to perform a scan procedure on the second channel prior to communicating on the second channel.

22. The device of claim 13, wherein the attribute of the detected radar signal is a bandwidth of the detected radar signal.

23. The device of claim 22, wherein the radar scan manager is further to determine that the bandwidth of the detected radar signal spans the current operating channel and an adjacent channel; and
wherein the channel selector is further to refrain from adjusting the channel weighting factor for the adjacent channel.

24. The device of claim 22, wherein the radar scan manager is further to determine that the bandwidth of the detected radar signal is within a bandwidth of the current operating channel; and
wherein the channel selector is further to adjust the channel weighting factor for an adjacent channel above the current operating channel and for an adjacent channel below the current operating channel.

25. An apparatus for wireless communications, comprising:
means for identifying an attribute of a radar signal detected on a current operating channel; and
means for adjusting, based at least in part on the identified attribute, a channel weighting factor assigned to a channel of a candidate channel list (CCL) adjacent to the current operating channel, wherein each channel in the CCL is associated with a channel weighting factor.

26. The apparatus of claim 25, further comprising:
means for selecting a new operating channel from the CCL based at least in part on the channel weighting factor.

27. The apparatus of claim 25, further comprising:
means for assigning each channel in the CCL to a radar classification; and
means for identifying a priority metric associated with a channel change between channels of the CCL, wherein the channel change is based at least in part on the radar classification.

28. A non-transitory computer-readable medium storing computer-executable code for wireless communication, the code executable by a processor to:
identify an attribute of a radar signal detected on a current operating channel; and
adjust, based at least in part on the identified attribute, a channel weighting factor assigned to a channel of a candidate channel list (CCL) adjacent to the current operating channel, wherein each channel in the CCL is associated with a channel weighting factor.

29. The non-transitory computer-readable medium of claim 28, wherein the code is further executable by the processor to:
select a new operating channel from the CCL based at least in part on the channel weighting factor.

30. The non-transitory computer-readable medium of claim 28, wherein the code is further executable by the processor to:
assign each channel in the CCL to a radar classification; and
identify a priority metric associated with a channel change between channels of the CCL, wherein the channel change is based at least in part on the radar classification.
